(19) United States
(12) Patent Application Publication
(10) Pub. No.: US 2009/0036174 A1
(43) Pub. Date: Feb. 5, 2009

(54) Mobile Telephone Case

(75) Inventors: Kyle Brandenburg, Philadelphia, PA (US); Edward Martin, Hollywood, FL (US)

Correspondence Address: LERNER GREENBERG STEMER LLP, P O BOX 2480, HOLLYWOOD, FL, 33022-2480, US

(73) Assignee: MARWARE, INC., Hollywood, FL (US)

(21) Appl. No.: 11/830,338

(22) Filed: Jul. 30, 2007

(51) Int. Cl. H04M 1/00

(52) U.S. Cl. 455/575.1

(57) ABSTRACT

A mobile telephone case includes a shell having at least one surface configured to partly surround the mobile telephone and a clamp into which the mobile telephone may be snapped. A winder is movable into and out of the shell between a closed storage position and an open position for receiving a cord. A mounting is disposed on the rear surface of the shell for attachment of a belt clip.

### BACKGROUND OF THE INVENTION

1. Field of the Invention

The invention relates to a case for a mobile telephone, such as the iPhone produced by Apple. The iPhone combines a mobile telephone, digital multimedia player and camera and has a multi-touch screen with a virtual keyboard and buttons as well as various ports, such as for charging, USB connection and ear bud connection.

2. Description of the Related Art

Many cases for digital media players and mobile telephones are available. Different cases cover or grasp the digital media player or mobile telephone in different ways and have various devices for attaching the case, such as belt clips. Some cases for the iPod and other digital media players have devices for accommodating ear bud cords, such as the Sidewinder produced by Marware, Inc. and described in co-pending U.S. application Ser. No. 11/331,986 and allowed U.S. Design Application No. 29/251,840. A case produced by Elecom has a winder projection at the side for winding an ear bud cord. Macally manufactures an Icesuit case having a rear winder storage location with a projection for an ear bud cord. However, due to the projections, both the Elecom and Macally Icesuit cases become larger and more cumbersome than a case without a storage location, whether or not the cord is wound on the winder. The Backwinder produced by Marware, Inc. and described in co-pending U.S. application Ser. No. 11/331,985 and allowed U.S. Design Application No. 29/251,854, and the Jam Jacket produced by DLO, are formed of a soft silicone rubber and therefore could not support a device for attaching the case.

None of the prior art cases provides a device for snapping the digital media player or mobile telephone into and out of the case along with a device for accommodating ear bud cords which does not enlarge the dimensions of the case and which is unobtrusive when retracted. Such cases also do not have a device for attaching the case as well. Furthermore, those prior art cases are not intended to accommodate the iPhone.

### SUMMARY OF THE INVENTION

It is accordingly an object of the invention to provide a mobile telephone case, which overcomes the hereinafore-mentioned disadvantages of the heretofore-known devices of this general type, which has a device for snapping the digital media player or mobile telephone into and out of the case and a device for accommodating ear bud cords which does not enlarge the dimensions of the case and which is unobtrusive when retracted. Furthermore, the case should have a device for attaching the case and should accommodate the iPhone.

With the foregoing and other objects in view there is provided, in accordance with the invention, a mobile telephone case, comprising a shell. The shell has at least one surface configured to partly surround the mobile telephone and a clamp into which the mobile telephone may be snapped. A winder is movable into and out of the shell between a closed storage position and an open position for receiving a cord. The shell may be formed of rigid yet resilient plastic and have at least one opening formed therein for accommodating at least one component of the mobile telephone, such as speakers. The mobile telephone can be easily removed from the shell with two fingers of one hand due to the snap clamp and the winder “disappears” when retracted. The shell has side and bottom surfaces and the at least one surface configured to partly surround the mobile telephone includes the side and bottom surfaces, which provide a support for the phone when being snapped into and out of the case. Thus, if the clamp is disposed at the top of the shell, the bottom surface of the shell provides a counter surface to the clamp when snapping the mobile telephone into and out of the shell.

In accordance with another feature of the invention, the shell has a front surface and a rear surface. The at least one surface configured to partly surround the mobile telephone includes the front surface, and a mounting is disposed on the rear surface for attachment of a belt clip. The mobile telephone can be easily removed from the shell as described above, even when mounted on a belt, and the fact that the winder retracts makes it comfortable to wear the case on a belt.

In accordance with a further feature of the invention, the shell has front, rear and side surfaces, and the winder has an outer contour matching an outer contour of the rear surface and one of the side surfaces when in the closed storage position. Therefore, when not accommodating a cord, the user is unaffected by the presence of the winder.

In accordance with an added feature of the invention, the shell has a rear surface, and the winder has at least one and preferably two legs for sliding into and out of at least one and preferably two channels formed in the rear surface between the closed storage position and the open position. The at least one leg has prongs for gripping surfaces of the at least one channel. This construction provides for a stable insertion and withdrawal of the winder and yet has no parts protruding from the shell when retracted.

In accordance with an additional feature of the invention, at least one stop projects into the at least one channel. The at least one stop rides in at least one blind slot formed in the at least one leg, and the at least one stop is struck by a closed end of the at least one blind slot in an end position. This prevents the winder from being over extended and falling out of the shell when fully extending the winder.

In accordance with yet another feature of the invention, the cord is a headphone or ear bud cord, and the winder has at least one slot formed therein for receiving the headphone or ear bud cord when in the open position. This feature provides a convenient storage location for winding a cord.

In accordance with a concomitant feature of the invention, the winder has a finger grip formed therein for extending the winder.

Other features which are considered as characteristic for the invention are set forth in the appended claims.

Although the invention is illustrated and described herein as embodied in a mobile telephone case, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, front-elevational view of a mobile telephone case according to the invention, with a winder in a closed storage position;

FIG. 2 is a side-elevational view of the mobile telephone case in the winder position of FIG. 1;

FIG. 3 is a rear-elevational view of the mobile telephone case in the winder position of FIG. 1;

FIG. 4 is a top-plan view of the mobile telephone case in the winder position of FIG. 1;

FIG. 5 is a bottom-plan view of the mobile telephone case in the winder position of FIG. 1;

FIG. 6 is a front-elevational view of the mobile telephone case according to the invention, with the winder in an open position;

FIG. 7 is a rear-elevational view of the mobile telephone case in the winder position of FIG. 6;

FIG. 8 is a top-plan view of the mobile telephone case in the winder position of FIG. 6;

FIG. 9 is a bottom-plan view of the mobile telephone case in the winder position of FIG. 6;

FIG. 10 is a front perspective view of the mobile telephone case in the winder position of FIG. 1;

FIG. 11 is a front perspective view of the mobile telephone case in the winder position of FIG. 1, with an inwardly-facing mobile telephone disposed therein;

FIG. 12 is a front perspective view of the mobile telephone case in the winder position of FIG. 1, with an outwardly-facing mobile telephone disposed therein;

FIG. 13 is a rear perspective view of the mobile telephone case in the winder position of FIG. 7, with an inwardly-facing mobile telephone disposed therein; and

FIG. 14 is an exploded, rear perspective view of the mobile telephone case according to the invention.

### DESCRIPTION OF THE PREFERRED EMBODIMENTS

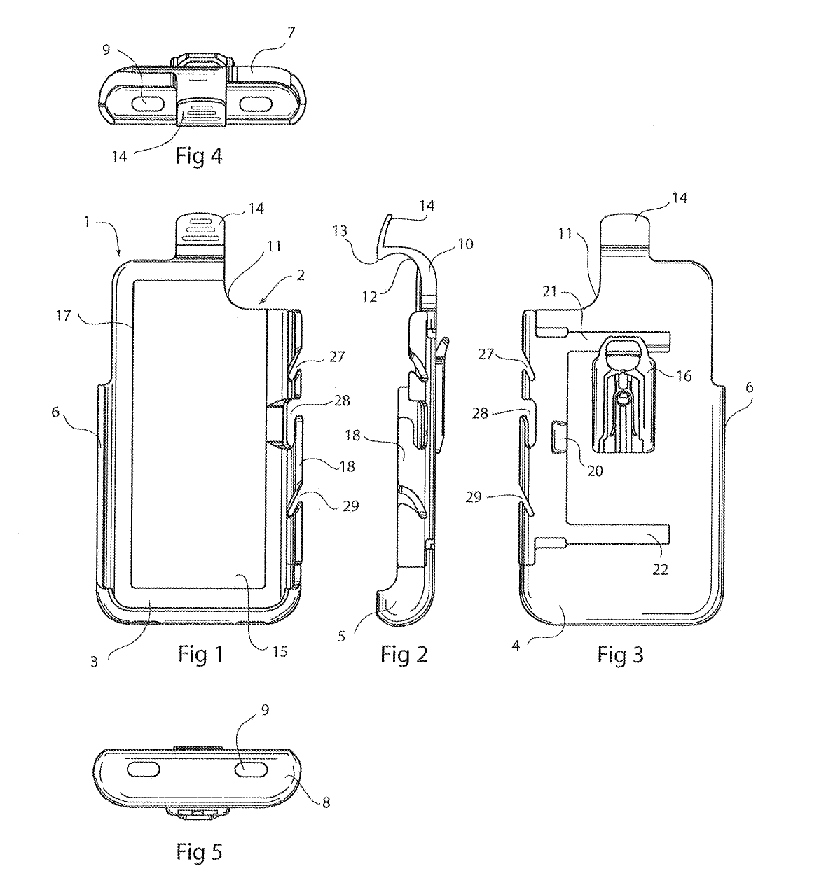

Referring now to the figures of the drawings in detail and first, particularly, to FIGS. 1-5 thereof, there is seen a mobile telephone case 1 having a shell 2 which may be formed of a rigid yet resilient plastic material. The shell 2 has a front surface 3, a rear surface 4, a right side surface 5, a left side surface 6, a top surface 7 and a bottom surface 8. The upper right corner of the shell 2 also has a recess 11 formed therein. Openings 9 are formed in the bottom surface 8 at a location below speakers of the mobile telephone. A liner 15, such as an adhesive-backed cloth or rubber, is placed within a recess 17 in the front surface 3 to provide a smooth surface for a mobile telephone. A clamp 10 protrudes upwardly from the top surface 7 and is curved forward to form a recess 12, a projection 13 and a tab 14, the purpose of which will be described in detail below. A mounting 16 projects from the rear surface 4 for attachment of a device for attaching the case, such as a belt clip, for example those manufactured by the firm Krussel under the designation MULTIDAPT® as is shown in allowed U.S. Design Application No. 29/251,840 and incorporated herein by reference.

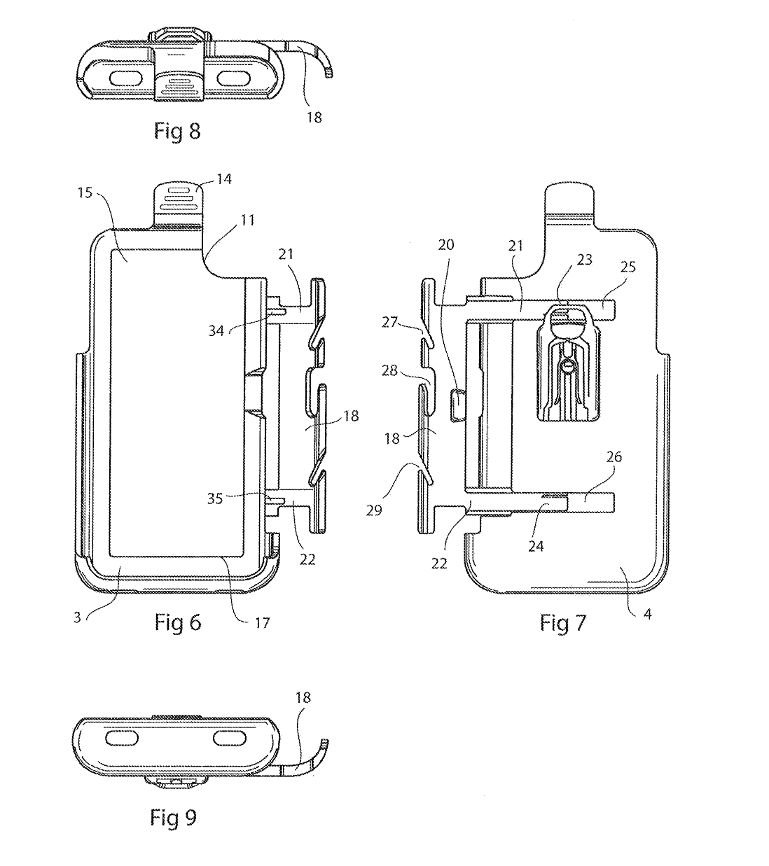

A winder 18, which is shown in a closed storage position in FIGS. 1-5, is disposed above the right side surface 5. In contrast thereto, the winder 18 is shown in an open position in FIGS. 6-9. The winder 18 has an outer contour matching the outer contour of the rear surface 4 and the side surface 5 of the shell 2 when in the closed storage position. It may be seen particularly clearly from FIGS. 3 and 7 that the winder 18 has a finger grip 20 which facilitates sliding the winder between the closed and the open positions. The winder 18 has two legs 21, 22 with respective forked prongs 23, 24. The legs 21, 22 slide in respective channels 25, 26 in the rear surface 4 to open and close the winder 18 toward the right side of the case (as seen in FIGS. 1 and 6) while the prongs grip surfaces in the channels. It is, however, understood that the winder could also open towards the left side or towards any surface not having openings to accommodate components of the mobile telephone. It is also understood that only one leg and only one channel or more than two legs and more than two channels could be provided. A cord for ear buds or headphones may be held in place by inserting the cord into slots 27, 28, 29 formed in the winder 18, as is shown in allowed U.S. Design Application No. 29/251,840.

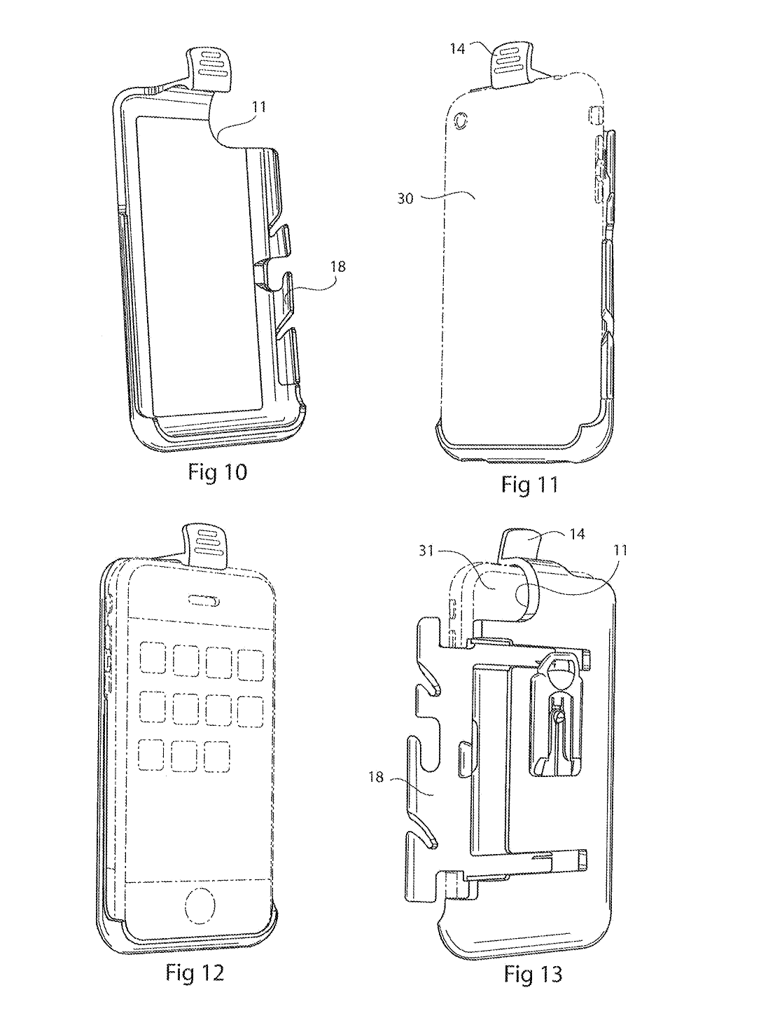

FIG. 10 shows the mobile telephone case 1 in a perspective view with the winder 18 in the closed storage position. In contrast thereto, FIGS. 11-13 show the mobile telephone case 1 in different perspective views with a mobile telephone 30, such as an iPhone, inserted into the shell 2. It may be seen that the bottom of the mobile telephone 30 is inserted within the right side surface 5, left side surface 6, bottom surface 8 and front surface 3. The clamp 10 holds the top of the mobile telephone 30 within the recess 12 and snapped behind the projection 13 with the bottom surface 8 providing a counter surface for the snap action. Since the shell 2 is formed of a rigid, resilient material, the tab 14 may be pressed backwards with the thumb of the right hand while pressing an upper corner 31 of the mobile telephone 30 within the recess 11 forwards with the index finger of the right hand, to unsnap the mobile telephone for removal from the shell 2. With the configuration shown, the left hand can be used to unsnap the mobile telephone 30 by pressing the thumb against the upper corner 31 and the index finger against the tab 14. Of course, the shell may be made with the opposite configuration instead. It is clear that the mobile telephone 30 may be placed within the case 1 while facing backward as in FIG. 11 or forward as in FIG. 12. FIG. 13 shows the winder 18 in the open position with the mobile telephone 30 in the case.

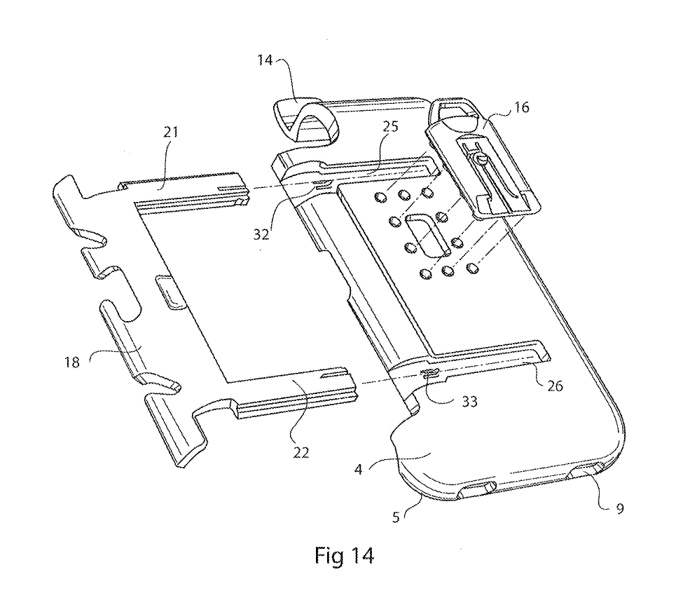

As is seen in the exploded view of FIG. 14, stops 32, 33 project into the channels 25, 26 in the rear surface 4. The stops 32, 33 ride in blind slots 34, 35 formed in front surfaces of the legs 21, 22, as is seen in FIG. 6. When fully extending the winder 18, the stops 32, 33 are struck by the closed ends of the blind slots 34, 35 to prevent the winder from being over extended and falling out of the case. FIG. 14 also shows that pins at the bottom of the mounting 16 protrude into matching holes in the rear surface 4 where they are fastened in place.

I claim:

1. A mobile telephone case, comprising:
a shell, said shell having at least one surface configured to partly surround the mobile telephone, and said shell having a clamp into which the mobile telephone may be snapped; and
a winder movable into and out of said shell between a closed storage position and an open position for receiving a cord.

2. The mobile telephone case according to claim 1, wherein said shell has a bottom surface providing a counter surface to said clamp when snapping the mobile telephone into and out of said shell.

3. The mobile telephone case according to claim 1, wherein said shell has a front surface and a rear surface, said at least one surface configured to partly surround the mobile telephone includes said front surface, and a mounting is disposed on said rear surface for attachment of a belt clip.

4. The mobile telephone case according to claim 1, wherein said shell has side and bottom surfaces and said at least one surface configured to partly surround the mobile telephone includes said side and bottom surfaces.

5. The mobile telephone case according to claim 1, wherein said shell has front, rear and side surfaces, and said winder has an outer contour matching an outer contour of said rear surface and one of said side surfaces when in the closed storage position.

6. The mobile telephone case according to claim 1, wherein said shell has a rear surface, and said winder has at least one leg for sliding into and out of at least one channel formed in said rear surface between said closed storage position and said open position.

7. The mobile telephone case according to claim 6, wherein said at least one leg is two legs for sliding into and out of two channels formed in said rear surface.

8. The mobile telephone case according to claim 6, wherein said at least one leg has prongs for gripping surfaces of said at least one channel.

9. The mobile telephone case according to claim 6, which further comprises at least one stop projecting into said at least one channel, said at least one stop riding in at least one blind slot formed in said at least one leg, and said at least one stop being struck by a closed end of said at least one blind slot to prevent said winder from being over extended and falling out of said shell when fully extending said winder.

10. The mobile telephone case according to claim 1, wherein the cord is a headphone or ear bud cord, and said winder has at least one slot formed therein for receiving the headphone or ear bud cord when in said open position.

11. The mobile telephone case according to claim 1, wherein said winder has a finger grip formed therein.

12. The mobile telephone case according to claim 1, wherein said shell is formed of rigid yet resilient plastic.

13. The mobile telephone case according to claim 1, wherein said shell has at least one opening formed therein for accommodating at least one component of the mobile telephone.
